(19) United States
(12) Patent Application Publication
(10) Pub. No.: US 2026/0216656 A1
(43) Pub. Date: Jul. 30, 2026

(54) SYSTEMS, KITS, AND METHODS FOR PREVENTING MEMBRANE FOULING

(71) Applicant: PathOtrak Inc., College Park, MD (US)

(72) Inventors: Sean P. MARTINOS, Washington, DC (US); Alexa Grace BALDWIN, Columbia, MD (US); Javier ATENCIA, Bethesda, MD (US)

(21) Appl. No.: 19/470,271

(22) PCT Filed: Apr. 1, 2024
(86) PCT No.: PCT/US2024/022538

§ 371 Date: Sep. 29, 2025

Related U.S. Application Data
(60) Provisional application No. 63/493,237, filed on Mar. 30, 2023.

(51) Int. Cl. B01D 65/08; B01D 61/14

(52) U.S. Cl. CPC B01D 65/08; B01D 61/145; B01D 61/147; B01D 2311/12; B01D 2311/2642; B01D 2321/168; B01D 2325/02833; B01D 2325/02834

(57) ABSTRACT

The present disclosure is generally directed to systems, kits, and methods for preventing membrane fouling and ameliorating filter spoilage in order to improve pathogen detection in food or beverage samples. Described herein are methods for introducing a growth medium or a buffer to a food or beverage to prepare a fluid sample and treating the fluid sample with a kosmotropic agent. The methods can further include flowing the fluid sample through a membrane, extracting a retentate of the fluid sample from the filtration system, and detecting presence of pathogen from the extracted retentate. The disclosures herein provide generally to systems, kits, and methods for improving a food safety test process for pathogen detection.

### CROSS-REFERENCE TO RELATED APPLICATIONS

This application claims the benefit of U.S. Provisional Patent Application No. 63/493,237, filed on Mar. 30, 2023, the content of which is herein incorporated by reference in its entirety.

### TECHNICAL FIELD

The disclosures herein relate generally to systems, kits, and methods for preventing membrane fouling and ameliorating filter spoilage caused by foods samples, as well as improving food safety test processes for pathogen detection.

### BACKGROUND

In the field of food processing, ensuring the safety and quality of food products is crucial. The spread of foodborne illnesses may be prevented through careful monitoring of food by producers and sellers, and detection of pathogens, such as foodborne microbes, which may be present in food processing lots. Pathogen detection processes involve enrichment, filtering of sample fluids (e.g., fluids having received a portion of a food product) to isolate and collect filtrate, and detection of e.g., foodborne microbes by polymerase chain reaction (PCR) and other known laboratory methods.

Though well established, the process of pathogen detection suffers from logistical inefficiencies and fails to eliminate all opportunities for the introduction of contaminants. However, many traditional detection methods are time-consuming, requiring several days to obtain results. Also, the conventional methods are not optimized for scalable, rapid, consistent manner to prevent membrane fouling and ameliorate filter spoilage caused by organic compounds. This is particularly true during enrichment and filtering. During filtering, meaningful scale may be hindered by the inability to process food samples. Especially, membrane fouling is a significant challenge in food and/or beverage processing. The accumulation and deposition of unwanted substances, known as foulants, often occurs on the surface or within the pores of a membrane. This membrane fouling can impact the quality, efficiency, and sustainability of food production and/or test processes, such as reduced filtration efficiency, decreased quality of food pathogen detection, and increased maintenance costs.

Membrane fouling can be caused by different types of foulants, including organic compounds (e.g., proteins, oils, and fats), inorganic compounds (e.g., salts and minerals), or biological materials (e.g., microorganisms, bacterial, algae, etc.). Methods to prevent membrane fouling caused by organic compounds include implementation of pre-treatment to reduce organic compounds, use of chemical agents (e.g., antiscalants or dispersants), modifications to the membrane surface, and adjustment of operational parameters.

There is a growing need for faster detection methods to facilitate timely decision-making in food safety management. Rapid and accurate detection of pathogens is essential for ensuring food safety and preventing outbreaks of foodborne illnesses. In particular, there is a need for new and improved systems, kits, and methods for food sample processing that mitigate or eliminate membrane fouling.

### BRIEF SUMMARY

Described herein are systems, kits, and methods for preventing membrane fouling and ameliorating filter spoilage caused by foods samples having organic compounds. Also, described herein are systems, kits, and methods for improving a food safety test process for pathogen detection.

The present disclosure relates to a method of reducing or preventing membrane fouling in a filtration system, the method comprising the steps of: a) introducing a growth medium or a buffer to a food or beverage to prepare a fluid sample; and b) treating the fluid sample with a kosmotropic agent. In further embodiments, the method comprises incubating the fluid sample for growth and proliferation of microorganisms or pathogens to detectable levels.

The present disclosure provides a method of reducing or preventing membrane fouling in a filtration system, the method comprising the steps of: a) introducing a growth medium or a buffer to a food or beverage to prepare a fluid sample; and b) treating the fluid sample with a kosmotropic agent.

The present disclosure further relates to a method of improving a food safety test process for pathogen detection, the method comprising the steps of: a) introducing a growth medium or a buffer to a food or beverage to prepare a fluid sample; b) treating the fluid sample with a kosmotropic agent; c) processing the fluid sample in a filtration system by passing the fluid sample through a membrane; d) extracting a retentate of the fluid sample from the filtration system; and e) detecting presence of pathogen from the extracted retentate. The method further comprises incubating the fluid sample for growth and proliferation of microorganisms or pathogens to detectable levels.

The present disclosure provides a method of improving a food safety test process for pathogen detection, the method comprising the steps of: a) treating a food sample with a wash medium comprising a kosmotropic agent; b) rinsing the food sample with the wash medium; c) passing a rinsate through a membrane in a filtration system; d) extracting a retentate of the rinsate from the filtration system; and e) detecting presence of pathogen from the extracted retentate.

In some embodiments of the methods, the fluid sample treated with the kosmotropic agent and/or the rinsate comprising the kosmotropic agent reduce or prevent the membrane fouling, thereby increasing a volume of the fluid sample that passes through a membrane in the filtration system at least 1.5 times more than the fluid sample not treated with the kosmotropic agent. The method of claim 1, wherein the membrane fouling is caused by at least one foulant in the food or beverage. In some embodiments, the at least one foulant comprises a protein, which is an animal protein or a meat protein. In some embodiments, the food comprises a leaf vegetable, chicken, beef, pork, cheese, dairy, spices, fruit, or combination thereof. In some embodiments, the kosmotropic agent does not interfere with the growth and proliferation of microorganisms or pathogens. In some embodiments, the treating of the kosmotropic agent causes aggregation of the at least one foulant.

In some embodiments of the methods, the treating of the fluid samples comprises the providing of the kosmotropic agent to the fluid sample in an amount effective to reduce the membrane fouling. In other embodiments, the kosmotropic agent in the wash medium is present in an amount effective to reduce the membrane fouling. In some embodiments, about 1% to about 20% of the fluid sample or wash medium comprises the kosmotropic agent. In some embodiments, the kosmotropic agent is polyethylene glycol (PEG), monosaccharide, disaccharide, polysaccharides, proline, betaine, trehalose, or combination thereof. In some embodiments, the kosmotropic agent is polyethylene glycol (PEG) with an average molecular weight of about 2,000 g/mol to about 25,000 g/mol. In some embodiments, the membrane is a microfiltration membrane having a pore size within the range of about 0.1 μm to about 10 μm pore size. In other embodiments, the ultrafiltration membrane has a pore size within the range of about 0.01 μm to about 0.1 μm pore size.

According to an embodiment, the present disclosure relates to a food safety test kit for pathogen detection comprising: a membrane, a growth medium, a wash medium, or a buffer, and a kosmotropic agent, which is polyethylene glycol (PEG), monosaccharide, disaccharide, polysaccharides, proline, betaine, trehalose, or combination thereof.

### BRIEF DESCRIPTION OF THE DRAWINGS

FIG. 1 depicts a flow chart of an improved food safety test process for pathogen detection using a kosmotropic agent, which can prevent reduce membrane or filtration fouling issues on food samples containing organic materials such as meat proteins. For enrichment of pathogen and/or microorganism, a growth medium is utilized and the food sample is incubated before passing through filters. The kosmotropic agent can be added at any point prior to the filtration.

FIG. 2 depicts a flow chart of an improved food safety test process for pathogen detection using a kosmotropic agent, which can prevent reduce membrane or filtration fouling issues on food samples containing organic materials such as meat proteins. This process does not include incubation and enrichment of pathogen and/or microorganism. Instead of a growth medium, a wash medium is utilized to rinse meat samples. The kosmotropic agent is included in the wash medium. Once the rinsates are obtained from the washing of the meat sample with the kosmotrope-added wash media, they are applied to the filtration.

FIG. 3 depicts pass-through volume and recovered percentage of poultry rinsate solution filtered in 10 minutes when different agents were examined to prevent and/or reduce membrane fouling. Chatropes, ionic kosmotropes, and non-ionic kosmotropes were tested.

### DETAILED DESCRIPTION

### Definitions

The term “a” or “an” refers to one or more of that entity, i.e. can refer to plural referents. As such, the terms “a,” “an,” “one or more,” and “at least one” are used interchangeably herein. In addition, reference to “an element” by the indefinite article “a” or “an” does not exclude the possibility that more than one of the elements is present, unless the context clearly requires that there is one and only one of the elements.

Throughout this application, the term “about” is used to indicate that a value includes the inherent variation of error for the device or the method being employed to determine the value, or the variation that exists among the samples being measured. Unless otherwise stated or otherwise evident from the context, the term “about” means within 10% above or below the reported numerical value (except where such number would exceed 100% of a possible value or go below 0%). When used in conjunction with a range or series of values, the term “about” applies to the endpoints of the range or each of the values enumerated in the series, unless otherwise indicated. As used in this application, the terms “about” and “approximately” are used as equivalents.

As used herein, the term “microbe” refers to any microorganisms, such as a bacteria, virus, fungi, or protozoa, cells, or other pathogens. Examples of microbes include infectious agents that may cause diseases or untoward or deleterious symptoms in an animal, such as human. As used herein, a microbe comprises bacteria, virus, fungi, and protozoa. The term “bacteria” is used herein to mean one or more viable bacteria existing or co-existing collectively in a test sample. The term may refer to a single bacterium (e.g., Aeromonas hydrophilia, Aeromonas caviae, Aeromonas sobria, Streptococcus uberis, Enterococcus faecium, Enterococcus faecalis, Bacillus sphaericus, Pseudomonas fluorescens, Pseudomonas putida, Serratia liquefaciens, Lactococcus lactis, Xanthomonas maltophilia, Staphylococcus simulans, Staphylococcus hominis, Streptococcus constellatus, Streptococcus anginosus, Escherichia coli, Staphylococcus aureus, Mycobacterium fortuitum, and Klebsiella pneumonia), a genus of bacteria (e.g., streptococci, pseudomonas and enterococci), a number of related species of bacteria (e.g., coliforms), an even larger group of bacteria having a common characteristic (e.g., all gram-negative bacteria), a group of bacteria commonly found in a food product, an animal or human subject, or an environmental source, or a combination of two or more bacteria listed above.

The term “microbe” also encompasses pathogens. The term “pathogen” as used herein refers to any microorganism that can cause disease. One exemplary embodiment of pathogen is foodborne pathogen that are present in the food and are the cause of major diseases, such as food poisoning. Exemplary of common foodborne pathogens include, but are not limited to, Salmonella, E. coli O157:H7, E. coli STEC, Listeria, Campylobacter, Clostridium botulinum, Staphylococcus aureus, Shigella, Toxoplasma gondii, Vibrio vulruficus, Norovirus, and Legionella.

As used herein, the terms “pathogen,” “target pathogen,” and “pathogen analyte(s)” are used interchangeably and refer to any microorganisms, cells, or other infectious agents that may cause diseases or untoward or deleterious symptoms in an animal, such as human. As used herein, pathogen comprises bacteria, virus, fungi, and protozoa. The term “bacteria” is used herein to mean one or more viable bacteria existing or co-existing collectively in a test sample. The term may refer to a single bacterium (e.g., Aeromonas hydrophilia, Aeromonas caviae, Aeromonas sobria, Streptococcus uberis, Enterococcus faecium, Enterococcus faecalis, Bacillus sphaericus, Pseudomonas fluorescens, Pseudomonas putida, Serratia liquefaciens, Lactococcus lactis, Xanthomonas maltophilia, Staphylococcus simulans, Staphylococcus hominis, Streptococcus constellatus, Streptococcus anginosus, Escherichia coli, Staphylococcus aureus, Mycobacterium fortuitum, and Klebsiella pneumonia), a genus of bacteria (e.g., streptococci, pseudomonas and enterococci), a number of related species of bacteria (e.g., coliforms), an even larger group of bacteria having a common characteristic (e.g., all gram-negative bacteria), a group of bacteria commonly found in a food product, an animal or human subject, or an environmental source, or a combination of two or more bacteria listed above. Exemplary of common foodborne pathogens include Salmonella, E. coli O157H7, E. coli STEC, Listeria, Campylobacter, Clostridium botulinum, Staphylococcus aureus, Shigella, Toxoplasma gondii, Vibrio vulrificus, and Norovirus. As used herein, the term “colony forming unit” (CFU) means live pathogens capable of forming a colony in a plate.

As used herein, the term “sample” or “test sample” means any material that contains, or potentially contains, biological material which could be contaminated by the presence of a pathogen or that could contain a microbe. Examples of samples for use in accordance with the disclosure include, but are not limited to, food samples, patient samples (e.g., feces or body fluids, such as urine, blood or cerebrospinal fluid), and environmental samples, such as drinking water or other fluids. A test sample may be taken from a source using techniques known to one skilled in the art.

A “membrane” as used herein refers to a selective barrier which allows some components of a mixture to pass through but while preventing other components, based on size, shape, electrical charge, polarity or other physical characteristic. Such components that selectively pass through include but are not limited to molecules, ions, small or large particles, proteins, nucleic acids, pathogens, etc. A membrane can be of animal or biological origin, or synthetic. The degree of selectivity of a membrane depends on the characteristics of the membrane and the component mixture that is passing through the membrane. For example, if components of the mixture are being separated based on size, the selectivity of the membrane will depend on the membrane pore size. Membranes can also be of various thickness, with homogeneous or heterogeneous structure. Membranes can be neutral or charged, and component passage through the membrane can be active or passive. Based on the physical characteristics of the membrane, one or more physical processes will affect or facilitate filtration. For example, pressure, electrical charge, concentration and the like can facilitate filtration according to the methods of the present disclosure.

As used herein, the term “microfiltration” refers to a type of physical filtration process where a contaminated fluid is passed through a special pore-sized membrane to separate microorganisms and suspended particles from a test sample. In some embodiments, the microfiltration membranes have a pore size within the range of about 0.1 microns (micrometer, or μM) to about 40 microns. In some embodiments, the microfiltration membranes have a pore size within the range of about 0.45 microns to about 40 microns. In some embodiments, the microfiltration membranes have a pore size within the range of about 1 micron to about 30 microns. In some embodiments, the microfiltration membranes have a pore size within the range of about 2 micron to about 20 microns. In some embodiments, the microfiltration membranes have a pore size within the range of about 10 microns. In one embodiment, the microfiltration membrane has a pore size of about 5 microns. In some embodiments, the microfiltration membranes have a pore size within the range of about 3 microns.

As used herein, the term “culture medium” or “growth medium” can be any type of medium used in laboratories or in vitro to grow different kinds of microorganisms or cells. A growth or a culture medium is composed of different nutrients that are essential for the growth of the microorganisms or the cells. A growth medium or culture medium can be solid, liquid, or semi-solid. In some embodiments, the culture medium is designed for cell culture. In other embodiments, the culture medium is designed for microbiological culture, which are used for growing microorganisms, such as bacteria or fungi. In some embodiments, the culture media for microorganisms are nutrient broths. In other embodiments, the culture media for microorganisms are agar plates.

A buffered solution is generally an aqueous-based solution consisting of a mixture of a weak acid and its conjugate base, or vice versa. As one of skill in the art will know, buffered solutions can be used to maintain pH at a stable value. Common buffer compounds include, but are not limited to, TAPS ([Tris(hydroxymethyl)methylamino]propanesulfonic acid), Bicine (2-(Bis(2-hydroxyethyl)amino)acetic acid), Tris (Tris(hydroxymethyl)aminomethane) or (2-Amino-2-(hydroxymethyl)propane-1,3-diol), Tricine (3-[N-Tris(hydroxymethyl)methylamino]-2-hydroxypropanesulfonic acid), TAPSO (3-[N-Tris(hydroxymethyl)methylamino]-2-hydroxypropanesulfonic acid), HEPES (4-(2-hydroxyethyl)-1-piperazineethanesulfonic acid), TES (2-[[1,3-dihydroxy-2-(hydroxymethyl)propan-2-yl]amino]ethanesulfonic acid), MOPS (3-(N-morpholino)propanesulfonic acid), PIPES (Piperazine-N,N′-bis(2-ethanesulfonic acid)), Cacodylate (Dimethylarsenic acid), and MES (2-(N-morpholino)ethanesulfonic acid).

As used herein, the term “fouling” refers to the deposition and attachment of inorganic compounds, organic compounds, microorganisms and biomolecular foulants onto the membrane surface or into the membrane pores, leading to pore clogging and permeability deterioration. Accordingly, the term “anti-fouling” refers to the effect of preventing, reducing, and/or eliminating fouling. Examples of the anti-fouling polymer are a functionalized hyperbranched polyglycerol, a hyperbranched polyimine, a zwitterionic copolymer obtainable by polymerizing 2-methacryloyloxyethyl lipoate with at least one of [2-(methacryloyloxy)ethyl]dimethyl-(3-sulfopropyl) ammonium hydroxide or 2-methacryloyloxyethylphosphorylcholine, and combinations thereof.

As used herein, the term “rinsate” refers to a liquid solution produced by rinsing a surface or a food item with water or a solvent. In embodiments, the solvent using for rinsing the surface or the food item is a wash solution (such as distilled water with 9% NaCl). In some embodiments, the solvent comprise a kosmotropic agent. In further embodiments, the solvent comprise a non-ionic kosmotropic agent. This process is typically performed to collect any residues, contaminants, or other substances present on the surface or within the food item. The rinsate is then collected for further analysis, which may include testing for the presence of pathogens, chemicals, pesticides, or other potential hazards to ensure food safety.

As used herein, the term “wash medium” can be any type of medium used in laboratories or in vitro to rinse different kinds of microorganisms or cells from the surface of a food sample. The wash medium of the present disclosure can be a distilled water or a saline solution, which includes a sodium chloride solution at different concentrations. In some embodiments, the wash medium is added with an additive, such as chaotropes, ionic kosmotropes, or non-ionic kosmotropes.

### Overview

“Membrane fouling,” which is interchangeably used as “filtration fouling” herein, is a common problem in many industrial processes, where the accumulation of particles, colloids, or other contaminants on the surface of a filter membrane reduces its efficiency and increases operational costs. Due to the membrane fouling, the productivity of membranes declines significantly over time during filtration. Membrane fouling has adverse effects on both the quality and quantity of the end products, and if fouling becomes irreversible, it significantly shortens the membrane's lifespan. It has been reported that membrane replacement due to fouling is one of main operating costs in membrane-based systems including a food sample testing.

When foulants are accumulated and deposited on the surface or within the pores of a filtration medium, this accumulation obstructs fluid flow and reduces the efficiency of the filtration process. This issue is encountered in various filtration systems such as membrane filtration, depth filtration, and surface filtration.

In some embodiments, membrane filtration is a process of separation that utilizes semi-permeable membranes to separate particles and substances based on their size, shape, charge, or molecular weight. In some embodiments, microfiltration is used for separating suspended solids, bacteria, and large colloidal particles from liquids. This microfiltration process is commonly employed in the food and beverage industry for clarification and sterilization of liquids by removing pathogens and/or unwanted materials.

Particularly, microfiltration of pathogenic bacteria from food safety test samples has been studied for decades. However, there are at least two major challenges of creating a commercially viable protocol, which are (i) fouling of filter membranes and (ii) recovery of bacteria from the filter.

Food test samples contain organic compounds such as proteins. For examples, raw meat or polyolefin swabs containing meat protein can cause the spoilage of membrane filters. If a lot of proteins are present in a fluid food test samples, the passing through of about 50-100 mL of the fluid samples can give rise to membrane or filter fouling. When using pure water as the liquid medium, membrane fouling is less of an issue, but it becomes more severe when working with media containing low salt concentrations. Rich growth media, particularly those used for bacterial growth, are highly vulnerable to this problem.

While there have been efforts to address this membrane fouling issues caused by microfiltration of bacteria from food samples in a fluid sample comprising the rich growth media. Many of these attempts have focused on using chaotropic agents to denature or hydrolyze organic compounds, as well as employing digestive enzymes to reduce the size of particles causing filter fouling.

The present disclosure provides solutions to address membrane fouling caused by foulants in food test samples or fluid samples of food or beverage products. In some embodiments, the fluid sample comprises a growth medium with a food product or a food test sample, both of which have organic compounds, including proteins, oils, and/or fats. In some embodiments, the food fluid sample comprises a wash medium with a food product or a food test sample, both of which have organic compounds, including proteins, oils, and/or fats.

The present disclosure relates to a method of reducing or preventing membrane fouling in a filtration system by adding a kosmotropic agent to a fluid food or beverage sample that is to pass through the filtration system. In some embodiments, the fluid sample treated with the kosmotropic agent can reduce or prevent the membrane fouling by causing coagulation or aggregation of organic compounds, such as proteins, oils, or fats. In some embodiments, the treatment of the kosmotropic agent can increasing efficiency of the flow of the fluid sample and a volume of the fluid sample that passes through a membrane in the filtration system.

The present disclosure relates to a method of improving a food safety test process for pathogen detection. After a kosmotropic agent is added to a fluid sample in which a food or beverage is mixed with a growth medium, a wash medium, or a buffer, the fluid sample in a filtration system can flow the fluid sample through a membrane. A retentate of the fluid sample, after passing the filtration system, is collected and extracted, and then presence of pathogen can be detected from the extracted retentate.

The present disclosure relates to a food safety test kit for pathogen detection, comprising: a membrane, a growth medium, a wash medium, or a buffer, and a kosmotropic agent.

### Pretreatment of Coagulants

The present disclosure provides an approach to minimize fouling, which is to pretreat the liquid or fluid samples prior to filtration. This pretreatment aims to reduce the presence of foulants in the liquid or fluid before they reach the membrane or modify their characteristics to minimize their interaction with the membrane material and structure. Pretreatment methods include coagulation, adsorption, oxidation, magnetic ion exchange (MIEX), biological treatment, or integrated pretreatments. Typically, this is achieved by introducing a fouling control additive into the liquid or fluid to condition it before filtration, altering or reducing the amount of foulants present.

In some embodiments, the effectiveness of liquid/fluid pretreatment depends on various factors, including the type and dosage of agents used (e.g., coagulants, adsorbents, flocculants, oxidizers), dosing modes (continuous or intermittent), dosing point, mixing efficiency, temperature, properties of the foulants (e.g., hydrophobicity, charge density, molecular weight, and size), and characteristics of the membrane (e.g., charge, hydrophobicity, surface morphology).

While conditioning through coagulation/flocculation is commonly used in conventional filtration technology (e.g., media filtration), its purpose is to prepare the liquid for filtration by addressing issues like media bed clogging, filter cake formation, or filter blinding.

The present disclosure provides that stable membrane operation requires various pretreatment processes, including physical and/or chemical methods.

The present disclosure teaches that coagulation or aggregation is an approach as a fouling control strategy in membrane filtration. In this approach, a coagulation additive is introduced into a liquid or fluid sample (e.g., growth medium or wash medium added to food or beverage product) to be filtered to facilitate the aggregation of foulants into larger flocs, thereby reducing or eliminating blockages in the membrane pores.

The present disclosure teaches that coagulants, which can be interchangeably used with aggregates, can be either organic or mineral.

In some embodiments, organic coagulants are utilized in membrane filtration systems to mitigate fouling by promoting the aggregation of foulants into larger particles, facilitating their removal from the liquid or fluid samples. Two examples of organic coagulants are polymeric coagulants and chitosan.

In some embodiments, polymeric coagulants, such as cationic polyacrylamides (CPAM) and polyDADMAC (polydiallyldimethylammonium chloride). These polymers function by adsorbing onto the surface of colloidal particles and organic matter, neutralizing their charges, and promoting particle aggregation. The resulting larger flocs are easier to remove by membrane filtration, reducing fouling potential.

In some embodiments, chitosan, derived from chitin found in the shells of crustaceans, is another organic coagulant used in liquid treatment. Chitosan has cationic properties, allowing it to effectively bind with negatively charged particles and organic compounds in liquid. It promotes the formation of larger flocs, which can be more efficiently removed by membrane filtration, thereby reducing fouling.

In other embodiments, mineral coagulants can be used in membrane filtration systems to prevent fouling by promoting the aggregation of foulants into larger particles, which can be more easily removed by the filtration process.

In other embodiments, examples of mineral coagulants include, but are not limited to, aluminum salts and iron salts. Aluminum salts includes aluminum sulfate (alum) and polyaluminum chloride (PAC), which work by destabilizing colloidal particles and organic matter present in the liquid or fluid samples, leading to their aggregation and precipitation.

In other embodiments, iron salts includes ferric chloride sulfate and ferrous sulfate, which function by forming insoluble hydroxide complexes that aid in the coagulation and precipitation of suspended particles and organic matter, similar to aluminum salts.

The resulting larger flocs from the treatment of aluminum or iron salts can be effectively removed by membrane filtration, reducing fouling potential. This helps to reduce fouling in membrane filtration systems by minimizing the accumulation of foulants on the membrane surface.

One problem with using coagulants is that unreacted coagulants to reach the membrane and react on its surface or within its porous structure. This can lead to fiber plugging or pore blocking, which exacerbates fouling rather than resolving it. Additionally, low-grade coagulants may cause fouling by Fe²⁺ and Mn²⁺, requiring intensive cleaning protocols to restore permeability.

While pretreatment measures condition the water or liquid to control fouling, conditioning the membrane itself is also recognized. For instance, patents WO2001027036A1 and WO2002044091A2 propose a filtration aid added to the water during each filter cycle to condition the membrane. This filtration aid contains fouling control particles that form a protective deposit layer on the membrane due to permeate flux. The layer retains foulants, shielding the membrane from fouling. At the end of each cleaning cycle, the deposit layer, along with the retained foulants, is removed from the membrane, typically through backwashing.

Various materials, such as ion-exchange resin particles and suspensions of iron hydroxides, aluminum oxides and hydroxides, sintered iron oxide particles, pulverized activated carbon, and clay particles, can be used as membrane fouling control additives. However, these materials exhibit adverse effects such as reactivity, abrasiveness, toxicity, or environmental concerns, and leading to membrane damage. As a result, this technology has not been widely implemented at an industrial scale. A similar system with the described membrane fouling control additive is also described in WO2017009792A1.

Controlling fouling in membrane filtration requires a combination of strategies tailored to specific applications while addressing environmental concerns and operational efficiency.

Prevention and/or Reduction of Membrane Fouling

One of the main barriers to greater use of membrane technologies is membrane fouling, which is caused by deposition and/or adsorption of fluid impurities such as organic substances and particulates on the membrane surface and/or in the pores. The accumulation of foulants is the cause of the membrane or filtration fouling. These foulants adhere to the filtration medium through physical adsorption, chemical interactions, or biological mechanisms, forming a layer that hampers fluid passage through the filter. Thus, preventing membrane fouling is crucial for maintaining the efficiency and longevity of membrane-based processes in various filtration systems.

Membrane fouling can occur in various types of membranes used in filtration, separation, and purification processes, including reverse osmosis, ultrafiltration, nanofiltration, and microfiltration membranes. In membrane filtration, the membrane acts as a barrier, allowing certain components to pass through while retaining others. Examples of membrane filtration include, but are not limited to, reverse osmosis (RO), nanofiltration (NF), ultrafiltration (UF), and microfiltration (MF).

In some embodiments, reverse osmosis (RO) is usually utilized for purification of water, concentration of solutions, and/or desalination. RO membranes have pore sizes typically in the range of about 0.0001 micrometers to about 0.001 micrometers, allowing for the removal of all organic compounds, all viruses, and most minerals, and only trace amounts of impurities are not removed.

In some embodiments, nanofiltration (NF) is a membrane filtration process that operates between reverse osmosis and ultrafiltration in terms of pore size. NF membranes have a pore size range between UF and RO membranes, typically in the range of about 0.001 to about 0.01 micrometers. NF membrane is used for the removal of divalent ions, organic molecules, most viruses, and certain smaller ions from water, making it suitable for water softening, color removal, and organic matter removal in wastewater treatment and industrial processes.

In some embodiments, ultrafiltration (UF) is commonly used for separating macromolecules and colloidal particles from liquids. UF membranes have pore sizes typically in the range of about 0.01 to about 0.1 micrometers, allowing for the removal of particles, bacteria, some viruses, proteins, and other contaminants from water or solutions.

In some embodiments, microfiltration (MF) is used for separating suspended solids, bacteria, and large colloidal particles from liquids. MF membranes have larger pore sizes compared to UF membranes, typically ranging from about 0.1 to about 10 micrometers. This MF is commonly employed in the food and beverage industry for clarification and sterilization of liquids. The present disclosure teaches that the MF is used for pathogen detection in food safety testing.

Preventing membrane fouling is crucial for maintaining the efficiency and longevity of membrane-based processes in various filtration systems. Since the safety and quality of food products are important in food processing, the detection of pathogens such as foodborne microbes is a critical part of the food processing. In order to detect pathogens, fluid samples of food products (e.g., fluid or medium containing a portion of a food product) are enriched and filtered to isolate and collect microbes as a filtrate, and methods well known in the art are used to detect microbes.

However, the pathogen detection process poses challenges in food safety testing, for example, complex sample matrices, low pathogen concentrations, diverse types of pathogens, variable pathogen behavior, non-culturable pathogens, etc. Also, detection methods, particularly using immunoassays and molecular techniques, can exhibit cross-reactivity with non-target substances present in food samples, which could lead to false-positive results. There are advanced detection techniques, such as immunoassays, LAMP (loop-mediated isothermal amplification) PCR-based assays or next-generation sequencing, however, they require specialized equipment with trained skilled person in the art, making them expensive and less accessible, for small-scale food producers or developing countries.

Low pathogen concentrations can be addressed by enrichment steps to increase the concentration of pathogens. While foodborne pathogens encompass a wide range of microorganisms, including bacteria, viruses, parasites, and fungi, each type of pathogen can be detected by using different detection methods. After differentiating pathogens by different membranes depending on sizes, detection methods (immunoassays, LAMP (loop-mediated isothermal amplification) PCR, and/or next-generation sequencing) are selected for each type of pathogens

However, among the challenges listed above, complex sample matrices are considered as one of the most challenging issue in detecting pathogens from food samples. Food samples often contain complex matrices that can interfere with pathogen detection. Organic components such as fats, proteins, carbohydrates, and other food particles can inhibit the performance of detection methods by interfering with the target analytes or causing background noise. Furthermore, the organic compounds or components give rise to membrane fouling by deposition and/or accumulation on the membrane surface and/or in the pores of the membranes. As a result, productivity of the membranes diminishes significantly with filtration time. So membrane replacement due to fouling is the single largest operating cost.

This significant operational challenge known as membrane fouling leads to a degradation of the membrane performance. Various types of fouling exist, including colloidal/particulate fouling, organic fouling, biofouling, and inorganic fouling or scaling.

In some embodiments, one approach to minimize fouling is the correct selection of the appropriate membrane and optimization of operating conditions tailored to the specific application. This involves considering the type of foulants present in liquid or fluid samples to be filtered. However, due to the diverse nature of fouling situations, this approach necessitates a wide range of membrane filters to address various fouling scenarios effectively. Consequently, projecting a filter application becomes more challenging as each application exhibits unique characteristics, requiring a nuanced approach to selection and optimization.

In some embodiments, another approach to minimize fouling is the periodic cleaning of the membrane, which can be achieved through physical, biological, or chemical methods. Physical cleaning methods include gas scouring, sponges, water jets, or backwashing using permeate. Abrasive cleaning agents may also be added to the liquid being filtered for enhanced physical cleaning. Chemical cleaning involves the use of various chemicals such as acids, bases, oxidants, enzymes, surfactants, complexing agents, and formulated detergents to remove foulants and impurities. While chemical cleaning is generally more effective at removing fouling that cannot be removed by physical cleaning. It generates additional waste and carries a negative environmental impact. On the other hand, physical cleaning, while potentially better for the environment, may need to be performed more frequently and may not always suffice to remove all foulants from the membrane. These membrane cleaning methods are collectively referred to as membrane remediation, aimed at restoring membrane functionality after fouling occurs. Physical and chemical cleaning methods can also be combined for enhanced efficacy. For instance, document EP1920821 outlines a method utilizing water-insoluble calcium carbonate among other agents for such combined cleaning purposes.

The present disclosure provides the microfiltration of pathogenic bacteria from food safety test samples as a commercially viable protocol, which overcome two of the challenges: the fouling of filter membranes and the retrieval of bacteria from the filter.

The microfiltration of bacteria from food samples have explored various approaches to address the membrane fouling issue. These attempts have focused on employing chaotropic agents to denature or hydrolyze organic compounds, along with the use of digestive enzymes to reduce the size of particles causing filter fouling.

Commonly used chaotropic agents in filtration processes include salts like guanidine hydrochloride, sodium iodide, and potassium thiocyanate. These agents effectively disrupt the water structure, facilitating the separation of contaminants from the filter surface.

Chaotropic agents are substances that disrupt the structure of water molecules, typically by increasing the solubility of hydrophobic molecules or destabilizing the water structure, leading to the separation of solutes from water. As chaotropic agents are primarily known for their applications in protein denaturation, they have been used in addressing membrane fouling in degradation of proteins in food test samples comprising organic substances, especially proteins. In some embodiments, examples of chaotropic agents include, but are not limited to, n-butanol, ethanol, guanidinium chloride, lithium perchlorate, lithium acetate, magnesium chloride, phenol, 2-propanol, sodium dodecyl sulfate (SDS), thiourea, urea, guanidine hydrochloride, guanidine thiocyanate, propylene glycol, phenol, sodium iodide, potassium thiocyanate, sodium perchlorate, lithium chloride, formamide, dimethyl sulfoxide (DMSO), and acetone.

Chaotropic agents can disrupt the interactions between foulants and the membrane surface, potentially reducing fouling in membrane filtration processes. They may enhance the solubility of foulants or destabilize foulant-membrane interactions, making it easier to remove foulants during cleaning processes. However, the effectiveness of chaotropic agents in addressing membrane fouling depends on various factors, including the type of foulants present, the characteristics of the membrane, and the specific operating conditions of the filtration system.

While chaotropic agents may offer some potential benefits in fouling mitigation, their use in membrane filtration systems for this purpose is less common compared to other fouling control strategies such as pretreatment, physical cleaning, chemical cleaning, and the use of coagulants or surfactants. Also, the application of chaotropic agents in membrane filtration may give potential negative impacts on membrane integrity, system performance, and environmental concerns.

Pretreatment methods and/or use of chaotropic agents have employed denaturing agents to try to remove protein from solutions, however, many denaturants are toxic to bacteria and will thus interfere with pathogen detection. Also, enzyme treatment such as proteases pose a similar problem, where the most active and promiscuous proteases can inflict damage to the extracellular proteins of live bacteria and decrease their viability.

The present disclosure provides new and novel solutions to address membrane fouling caused by foulants in food test samples or fluid samples of food or beverage products by using a kosmotropic agent. In embodiments, the kosmotropic agent is particularly useful as an additive as it is innocuous to pathogens (such as Salmonellae and E. coli) to be detected for food safety test.

### Kosmotropic Agents

Kosmotropic agents are substances that stabilize the structure of water molecules, typically by promoting water-water interactions and reducing the solubility of solutes in water. The kosmotropic agents can cause water molecules to favorably interact with macromolecules such as proteins. Intermolecular interactions are also stabilized by kosmotropic agents.

In various embodiments, examples of a kosmotropic agent include, but are not limited to, salts (e.g., sodium sulfate, ammonium sulfate, sodium chloride, potassium chloride), sugars (e.g., glucose, sucrose, trehalose, mannitol), polyols (glycerol, ethylene glycol, propylene glycol, polyethylene glycol (PEG)), and peptides with hydrophilic residues (phenylalanine, methionine, tryptophan, isoleucine, valine, leucine, alanine, proline), ethanolamine, and betaine. In some embodiments, the kosmotropic agent is PEG.

PEGs are prepared by polymerization of ethylene oxide and are commercially available over a wide range of molecular weights from 300 g/mol to 500,000,000 g/mol. In some embodiments, the kosmotropic agent is polyethylene glycol (PEG) with an average molecular weight of about 1,000 g/mol to about 40,000 g/mol, about 1,500 g/mol to about 35,000 g/mol, about 2,000 g/mol to about 30,000 g/mol, about 3,000 g/mol to about 25,000 g/mol, about 4,000 g/mol to about 25,000 g/mol, about 5,000 g/mol to about 25,000 g/mol, about 6,000 g/mol to about 25,000 g/mol, about 7,000 g/mol to about 25,000 g/mol, about 8,000 g/mol to about 25,000 g/mol, about 9,000 g/mol to about 25,000 g/mol, about 10,000 g/mol to about 25,000 g/mol, about 11,000 g/mol to about 25,000 g/mol, about 12,000 g/mol to about 25,000 g/mol, about 13,000 g/mol to about 25,000 g/mol, about 14,000 g/mol to about 25,000 g/mol, about 15,000 g/mol to about 25,000 g/mol, about 16,000 g/mol to about 25,000 g/mol, about 17,000 g/mol to about 25,000 g/mol, about 18,000 g/mol to about 25,000 g/mol, about 19,000 g/mol to about 25,000 g/mol, and about 20,000 g/mol to about 25,000 g/mol.

In some embodiments, the kosmotropic agent is polyethylene glycol (PEG) with an average molecular weight of about 2,000 g/mol to about 5,000 g/mol, about 2,100 g/mol to about 4,900 g/mol, about 2,200 g/mol to about 4,800 g/mol, about 2,300 g/mol to about 4,700 g/mol, about 2,400 g/mol to about 4,600 g/mol, about 2,500 g/mol to about 4,500 g/mol, about 2,600 g/mol to about 4,400 g/mol, about 2,700 g/mol to about 4,300 g/mol, about 2,800 g/mol to about 4,200 g/mol, about 2,900 g/mol to about 4,100 g/mol, and about 3,000 g/mol to about 4,000 g/mol. In some embodiments, the kosmotropic agent is polyethylene glycol (PEG) with an average molecular weight of about 3,050 g/mol, about 3,100 g/mol, 3,150 g/mol, about 3,200 g/mol, 3,250 g/mol, about 3,300 g/mol, 3,350 g/mol, about 3,400 g/mol, 3,450 g/mol, or about 3,500 g/mol.

In some embodiments, the kosmotropic agent is polyethylene glycol (PEG) with an average molecular weight of about 2,000 g/mol to about 25,000 g/mol. In some embodiments, the kosmotropic agent is polyethylene glycol (PEG) with an average molecular weight of about 3,000 g/mol to about 20,000 g/mol.

In various embodiments, a kosmotropic agent is employed to enhance the hydrophobic interaction between the proteins present in food samples. Examples of food samples having proteins include, but are not limited to, (1) a raw, processed, or cooked meat (such as beef, chicken, pork, lamb, turkey, duck, venison, bison, rabbit, quail, goose, pheasant, kangaroo, ostrich, and emu); (2) a raw, processed, or cooked fish (such as salmon, tuna, cod, trout, snapper, tilapia, halibut, mahi-mahi, swordfish, mackerel, sardines, haddock, bass, perch, catfish); (3) a raw, processed, or cooked shell fish (such as shrimp, crab, lobster, crawfish, clams, mussels, oysters, scallops, crayfish, squid); (4) a raw, processed, or cooked leaf vegetables (such as spinach, lettuce (various types including romaine, iceberg, butterhead, and leaf lettuce), kale, broccoli, cauliflower, corn, eggplant, bean, pea, leak, asparagus, celery, squash, pepper, swiss chard, collard greens, arugula, cabbage (including green, red, and savoy varieties), bok choy, watercress, mustard greens, turnip greens, and beet greens); (5) a raw, processed, or cooked root vegetables (such as carrots, potatoes (including various types such as russet, red, yellow, and sweet potatoes), beets, radishes (including red, white, and daikon varieties), turnips, rutabagas, parsnips, onions (including bulb onions, green onions, and shallots), garlic, ginger, turmeric, artichokes, cassava (also known as yuca), horseradish, taro, and yam); (6) eggs; (7) food or beverage products such as dairy, cheese, yogurt, ice cream, spices, broth, butter, peanut butter, milk, water; (7) swab and/or cloth that have been in contact with the food or beverage listed in (1)-(6); and (8) swab and/or cloth that have been in contact with environmental samples.

In some embodiments, some examples of food samples include, but are not limited to: dairy products such as cheese, yogurt, ice cream or milk, including raw milk; meat such as beef, pork, minced meat, turkey, chicken or other poultry products; ground meat such as ground beef, ground turkey, ground chicken, ground pork; eggs; produce, including fruits and vegetables; peanut butter; seafood products including oysters, pickled salmon or shellfish; or juice, such as fruit or vegetable juice. In further embodiments, the test sample is a vegetable, such as any consumable produce, such as but not limited to lettuce, spinach, kale, broccoli, cauliflower, corn, eggplant, beans, carrots, collards, peas, leaks, onions, cabbage, asparagus, beats, celery, and squash.

In further embodiments, examples of environmental samples include, but are not limited to, drinking water or other fluids, soil samples and non-consumable plant samples. In certain embodiments, the sample must comprise at least a liquid portion. When the starting sample is a solid, such as a consumable vegetable or consumable meat, starting sample is placed in a liquid. The liquid portion of the sample in which the starting sample can be placed is often water or an aqueous-based liquids, such as but not limited to a buffer, or an acid or a base. Examples of aqueous-based liquids include saline, phosphate-buffered solution (PBS), Tris-buffered solution (TBS) and the like. In specific embodiments, the water in which the starting sample material is placed sterilized, or filtered and/or bacteria-free.

In additional embodiments, the water in which the starting sample material is also or is instead de-ionized. In other embodiments, the liquid portion of the sample in which the starting sample can be placed is an organic-based solvent. In still other embodiments, the liquid portion of the sample in which the starting sample can be placed is a cell-culture medium. When the starting sample material is liquid, the starting sample material may be “diluted” by mixing it with a liquid, such as but not limited to water. In embodiments, the test sample is selected from the group comprising water, food sample, human tissue, human fluids, animal tissue, animal fluids, plant tissue, clinical sample, and environmental sample. A test sample may be taken from a source using techniques known to one skilled in the art. In some embodiments, the test sample is a fluid sample. In some embodiments, the test sample can be a solid sample. In some embodiments, the test sample comprises, or can be separated into, fluid portion and sediment particles.

In other embodiments, the water in which the starting sample material is distilled. In further embodiments, the liquid portion of the sample in which the starting sample can be placed is a wash medium, which can be a distilled water or a saline solution (such as 9% sodium chloride in distilled water). When the starting sample material is not liquid (such as meat samples), the starting sample material is rinsed with the wash medium, which may comprise sodium chloride to encourage detachment of bacteria from the meat surface.

In order to pathogen detection from food or beverage for its safety test, the food or beverage is introduced with a growth medium, a wash medium, or a buffer for membrane filtration. In embodiments, the type of food or beverage may be chicken, beef, pork, fish, leaf vegetables, root vegetables, fruit, cheese, dairy, swab, cloth, spices, broth, milk, water, and the like, or any other food or beverage requiring evaluation for presence of pathogens. When the food or beverage is a swab or cloth, the swab or cloth may have been in contact with beef, pork, and vegetables or may have been used as an environmental swab to obtain environmental samples.

In embodiments, the liquid or fluid sample comprises a growth medium, a wash medium, or a buffer with a food product or a food test sample, both of which have organic compounds, including proteins, oils, and/or fats.

Kosmotropic agents can potentially be used for addressing membrane fouling by promoting the formation of a stable hydration layer around the membrane surface. This hydration layer may inhibit the adhesion of foulants to the membrane and reduce fouling tendencies. Additionally, kosmotropic agents may enhance the stability and performance of membranes by preserving their structural integrity.

As opposed to chaotropic agents, kosmotropic agents (also known as kosmotropes) stabilize the structure of water molecules in a solution, reducing their mobility and enhancing their ordering. This results in a decrease in the entropy of the solvent. In some embodiments, kosmotropic agents can increase the size of protein aggregates and even to precipitate them.

The present disclosure teaches the use of kosmotropes to prevent the fouling of filtration membranes. This approach is contrary to ordinary skilled persons in the art would recognize because any protein aggregates in solution would potentially become larger than the filtering membranes pore size. Skilled persons in the art would understand that, if the aggregates are smaller, they should pass through the membrane pores without clogging, and if the aggregates are larger, they should clog the pores and eventually the whole filter.

The present disclosure teaches that the addition of kosmotropic agent (e.g., PEG 3350) to a liquid food sample containing proteins and protein aggregates surprisingly decreases the rate of membrane fouling during the filtration for pathogen detection in food safety testing. The present disclosure teaches that, by incorporating PEG (e.g., from PEG 3350 to PEG 20,000 or even higher molecular weight than PEG 20,000), at varying concentrations into liquid or fluid food samples containing organic substances (e.g., proteins), the filtration process is enhanced due to less or no membrane fouling, allowing for the passage of significantly larger volumes of liquid through our filters compared to the samples without PEG added. In embodiments, PEG with higher average molecular weights can precipitate or aggregate proteins in food or beverage samples, and increases the volume of protein-rich liquid that can be filtered, with aggregates being captured by prefiltration compared to a PEG-free control. The present disclosure provides improved performance of preventing or reducing membrane fouling, when PEG with higher molecular weights is added to the liquid or fluid food samples. The present disclosure teaches that PEG with an average molecular weight of about 2,000 g/mol to about 25,000 g/mol, though PEG of other average molecular weights can perform well to reduce or prevent membrane fouling for pathogen detection in food safety test.

We hypothesize that other kosmotropic agents would yield the same effect, like mono-, di-, and small polysaccharides, proline, betaine, trehalose and other such chemicals

In embodiments, the ability to filter bacteria from a larger proportion of the sample liquid enhances the total bacterial capture on the filters, consequently increasing the likelihood of downstream detection.

In embodiments, the kosmotropic agent (e.g., PEG with high molecular weight) is added or introduced to a liquid or fluid sample. In embodiments, a concentration of the kosmotropic agent in the liquid or fluid sample is about 0.1%, about 0.2%, about 0.3%, about 0.4%, about 0.5%, about 0.6%, about 0.7%, about 0.8%, about 0.9%, about 1.0%, about 1.5%, about 2.0%, about 2.5%, about 3.0%, about 3.5%, about 4.0%, about 4.5%, about 5.0%, about 5.5%, about 6.0%, about 6.5%, about 7.0%, about 7.5%, about 8.0%, about 8.5%, about 9.0%, about 9.5%, about 10.0%, about 11.0%, about 12.0%, about 13.0%, about 14.0%, about 15.0%, about 16.0%, about 17.0%, about 18.0%, about 19.0%, or about 2.0%. In some embodiments, the addition of the kosmotropic agent does not impede the growth of pathogenic bacteria at concentrations ranging from about 1.0% to about 20.0%, about 1.5% to about 15.0%, about 2% to about 10%, or about 5 to about 10%. In further embodiments, the addition of the kosmotropic agent to the liquid or fluid samples of the present disclosure maintains stability even when the solution of the kosmotropic agent is subjected to autoclave sterilization. In further embodiments, performance remains high after 1 hour, 2 hours, 3 hours, 4 hours, 5 hours, 6 hours, 7 hours, 8 hours, 9 hours, 10 hours, 11 hours, 12 hours, 1 day, 2 days, 3 days, 4 days, 5 days, 6 days, 7 days, 8 days, 9 days, 10 days, 11 days, 12 days, 13 days, 14 days or longer of storing an autoclaved solution. Performance remains high after two weeks of storing an autoclaved solution, allowing usability and capacity of the kosmotropic agent to prevent or reduce membrane fouling, thereby significantly bolstering concentration and detection of pathogens in food samples.

### Methods of Reducing or Preventing Membrane Fouling in a Filtration System

The present disclosure provides a method of reducing or preventing membrane fouling in a filtration system. In embodiments, the method comprises the steps of introducing a growth medium, a wash medium, or a buffer to a food or beverage to prepare a fluid sample and treating the fluid sample with a kosmotropic agent. In some embodiments, the method described above further comprises incubating the fluid sample for growth and proliferation of microorganisms or pathogens to detectable levels.

In some embodiments, the fluid sample treated with the kosmotropic agent reduces or prevents the membrane fouling, thereby increasing a volume of the fluid sample that passes through a membrane in the filtration system. In some embodiments, the fluid sample that passes through a membrane increases at least 1.1, at least 1.2, at least 1.3, at least 1.4, at least 1.5, at least 1.6, at least 1.7, at least 1.8, at least 1.9, at least 2, at least 3, at least 4, at least 5, at least 6, at least 7, at least 8, at least 9, at least 10 times more than the fluid sample not treated with the kosmotropic agent. In some embodiments, the fluid sample treated with the kosmotropic agent reduces or prevents the membrane fouling, which increases a volume of the fluid sample that passes through a membrane in the filtration system at least 1.5 times more than the fluid sample not treated with the kosmotropic agent. In further embodiments, the fluid sample treated with the kosmotropic agent passes through the membrane in the filtration system at least 1.5 to 7 times or at least 1.5 to 8 times in volume more than the fluid sample not treated with the kosmotropic agent.

In some embodiments, the membrane fouling is caused by at least one foulant in the food or beverage. In some embodiments, the at least one foulant comprises a protein. In some embodiments, the protein is an animal protein or a meat protein. In some embodiments, the food or beverage comprises a leaf vegetable, chicken, beef, pork, cheese, dairy, spices, fruit, or combination thereof.

In some embodiments, the kosmotropic agent does not interfere with the growth and proliferation of microorganisms or pathogens. In some embodiments, the treating of the kosmotropic agent causes aggregation of the at least one foulant. In some embodiments, the kosmotropic agent is polyethylene glycol (PEG), monosaccharide, disaccharide, polysaccharides, proline, betaine, trehalose, or combination thereof. In some embodiments, treating the fluid samples comprises providing the kosmotropic agent to the fluid sample in an amount effective to reduce the membrane fouling. In some embodiments, about 1% to about 20%, about 1.5% to about 15%, or about 2% to about 10% of the fluid sample comprises the kosmotropic agent. In further embodiments, the kosmotropic agent is polyethylene glycol (PEG) with an average molecular weight of about 2,000 g/mol to about 25,000 g/mol or about 3,000 g/mol to about 20,000 g/mol.

In some embodiments, the membrane is a microfiltration membrane or an ultrafiltration membrane. In some embodiments, the microfiltration membrane has a pore size within the range of about 0.1 μm to about 10 μm pore size, and the ultrafiltration membrane has a pore size within the range of about 0.01 μm to about 0.1 μm pore size.

The present disclosure teaches a method of reducing or preventing membrane fouling in a filtration system, the method comprising the steps of: a) treating a food sample with a wash medium comprising a kosmotropic agent; b) rinsing the food sample with the wash medium; and c) passing a rinsate through a membrane in a filtration system. In some embodiments, the rinsate comprising the kosmotropic agent reduces or prevents the membrane fouling, thereby increasing a volume of the rinsate that passes through the membrane at least 1.5 times more than the food sample treated with a wash medium not comprising the kosmotropic agent.

### Methods of Improving a Food Safety Test Process for Pathogen Detection

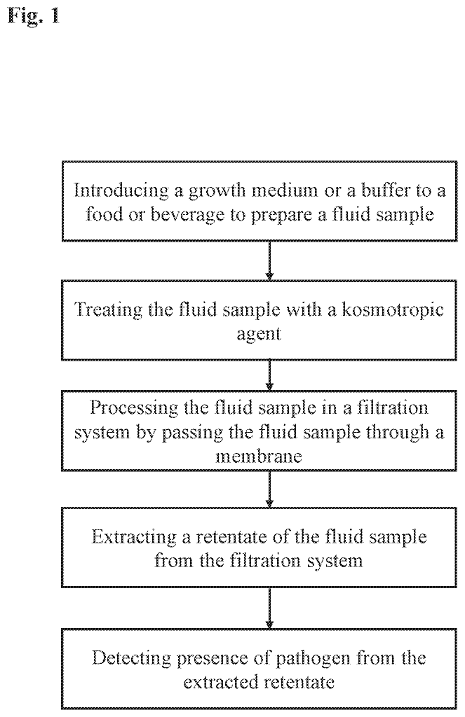

The present disclosure provides a method of improving a food safety test process for pathogen detection, the method comprising the steps of: a) introducing a growth medium or a buffer to a food or beverage to prepare a fluid sample; b) treating the fluid sample with a kosmotropic agent; c) processing the fluid sample in a filtration system by passing the fluid sample through a membrane; d) extracting a retentate of the fluid sample from the filtration system; and e) detecting presence of pathogen from the extracted retentate. In some embodiments, the fluid sample treated with the kosmotropic agent reduces or prevents membrane fouling, thereby increasing a volume of the fluid sample that passes through a membrane in the filtration system at least 1.5 times more than the fluid sample not treated with the kosmotropic agent. FIG. 1 presents a flow chart of an improved food safety test process for pathogen detection using a kosmotropic agent to prevent or reduce membrane fouling. In this method shown in FIG. 1, the enrichment and incubation step of pathogens and/or microbes is included by the use of the growth medium for the growth and proliferation of pathogens and/or microbes. The kosmotropic agent can added to the growth medium before treating the food sample or to the growth medium that is already introduced to the food sample.

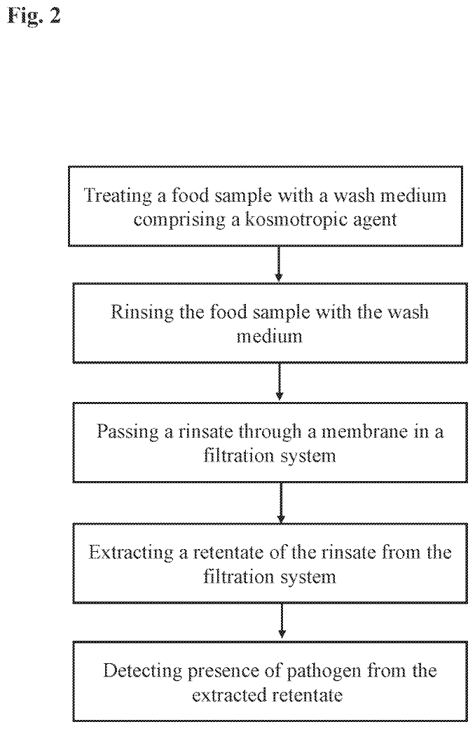

The present disclosure provides a method of improving a food safety test process for pathogen detection, the method comprising the steps of: a) treating a food sample with a wash medium comprising a kosmotropic agent; b) rinsing the food sample with the wash medium; c) passing a rinsate through a membrane in a filtration system; d) extracting a retentate of the rinsate from the filtration system; and e) detecting presence of pathogen from the extracted retentate. In some embodiments, the rinsate comprising the kosmotropic agent reduces or prevents the membrane fouling, thereby increasing a volume of the rinsate that passes through the membrane at least 1.5 times more than the food sample treated with a wash medium not comprising the kosmotropic agent. FIG. 2 presents another flow chart of an improved food safety test process for pathogen detection using a kosmotropic agent to prevent or reduce membrane fouling. In this method shown in FIG. 2, the enrichment and incubation step of pathogens and/or microbes is excluded. The food rinsate is prepared by washing the food sample with the wash medium comprising the kosmotropic agent.

In some embodiments, the detecting of the presence of the pathogen comprises performing one or more of immunoassay, loop-mediated isothermal amplification (LAMP), polymerase chain reaction (PCR), real-time PCR, and quantitative real-time PCR.

### Food Safety Test Kits

The present disclosure provides a food safety test kit for pathogen detection comprising: a membrane, a growth medium, a wash medium, or a buffer, and a kosmotropic agent. In embodiments, the kosmotropic agent is polyethylene glycol (PEG), monosaccharide, disaccharide, polysaccharides, proline, betaine, trehalose, or combination thereof. In some embodiments, the kosmotropic agent is polyethylene glycol (PEG) with an average molecular weight of about 2,000 g/mol to about 25,000 g/mol or about 3,000 g/mol to about 20,000 g/mol. In some embodiments, the membrane is a microfiltration membrane having a pore size within the range of about 0.1 μm to about 10 μm pore size or an ultrafiltration membrane having a pore size within the range of about 0.01 μm to about 0.1 μm pore size.

Rapid and accurate detection of pathogens is essential for ensuring food safety and preventing outbreaks of foodborne illnesses, unlike time-consuming traditional detection methods. The present disclosure provides a significant improvement for faster detection methods, systems and kits to facilitate timely decision-making in food safety management by addressing membrane or filtration fouling by the use of at least one kosmotropic agent of the present disclosure.

### EXAMPLES

The following examples are given for the purpose of illustrating various embodiments of the disclosure and are not meant to limit the present disclosure in any fashion. Changes therein and other uses which are encompassed within the spirit of the disclosure, as defined by the scope of the claims, will occur to those skilled in the art.

### Example 1: Impact of PEG (Average MW 3350) on Pass-Through Volume of Food Fluid Samples

This experiment was conducted to evaluate the impact of PEG on the pass-through volume of various food fluid samples. Briefly, a microfilter membrane was mounted on a filter holder. Each liquid sample was prepared as follows; (1) chicken rinsate with buffered peptone water and (2) beef swap with buffered peptone water (i.e., swab that was in contact with beef and then soaked with buffered peptone water). Each food sample (i.e., matrix in Table 1) was divided into a same volume of two samples; one for treatment with PEG and one as a control without PEG treatment. The Buffered Peptone Water (BPW) is used as a growth medium and as the basis of carbohydrate fermentation media, and allows for the non-selective pre-enrichment of pathogens and/or microbes (such as Salmonella spp.) from food samples. The liquid samples were incubated to enrich pathogens and/or microbes in the BPW. For PEG treatment, PEG (Average MW 3350) was added at concentrations between 2.5-10% to food samples containing abundance of sarcoplasmic protein. A volume of each liquid sample was passed through the membrane filter, followed by measuring pass-through volume and pass-through rate. Table 1 represents data from side-by-side experiments of samples treated with PEG and samples not treated with PEG. All non-PEG media was used as a control to examine the effectiveness of PEG to prevent or reduce membrane fouling by comparing pass-through rate. All the experiments were conducted by single-day comparisons to for reduce any sample variability throughout time.

TABLE 1
Average percentage of pass-through volume of food
liquid samples with and without PEG 3350.

| | | % of total | % of total | |
|---|---|---|---|---|
| | | Pass-through | Pass-through | Volume |
| | | volume | volume | Ratio |
| | | (mL passed | (mL passed | (w/o PEG |
| Experiment | Matrix | without PEG) | with PEG) | vs w/PEG) |
| #1 | Chicken rinsate | 12% | 74.6% | 1:6.217 |
| | with Buffered | (60 out of | (373 out of | |
| | Peptone Water | 500 mL; | 500 mL; | |
| | (BPW) | N = 1) | N = 1) | |
| #2 | Chicken rinsate | 21.6% | 54% | 1:2.492 |
| | with BPW | (65 out of | (162 out of | |
| | | 300 mL; | 300 mL; | |
| | | N = 4) | N = 4) | |
| #3 | Beef swab | 61.7% | 97.3% | 1:1.575 |
| | in BPW | (139 out of | (219 out of | |
| | | 225 mL; | 225 mL; | |
| | | N = 12) | N = 2) | |

The addition of PEG 3350 at a concentration of 2.5% to the food samples showed improvement over no PEG 3350 treatment (i.e., 0% concentration). A significant improvement was shown when PEG 3350 was added to the samples at a concentration of 5-10%.

Data from Experiment 1 show that the pass-through volume of the PEG-treated liquid sample is at least 6 times higher than that of the non-PEG treated sample (12% pass-through rate in non-PEG samples; 74.6% pass-through rate in PEG treated samples). Data from Experiment 2 show at least 2.5 times higher pass-through rate in PEG-treated samples (21.6% pass-through rate in non-PEG samples; 54% pass-through rate in PEG treated samples). Experiment 3 provides a similar trend with at least 1.5 times higher pass-through rate (i.e., volume percentage) in the liquid sample from beef swab in the PET treated condition.

### Example 2: Impact of Kosmotropic Agents on Pass-Through Volume of Poultry Rinsates Comprising a Salt

In order to encourage detachment of bacteria from the surface of meat, sodium chloride can be added to the rinsing medium. However, the use of sodium chloride drastically reduces pass-through efficiency. This experiment was conducted to determine the pass-through volume of poultry rinsates by the addition of (i) distilled water; (ii) chaotrope (e.g., ammonium sulfate, sodium carbonate, magnesium sulfate); (iii) ionic kosmotrope (e.g., ammonium sulfate, sodium carbonate, and magnesium sulfate); and (iv) non-ionic kosmotrope (e.g., glucose and PEG average MW 20,000). Poultry rinsates were prepared by rinsing the poultry vigorously with the following wash media; (1) distilled water (positive control), (2) 9% sodium chloride solution (9% NaCl in distilled water) (negative control), (3) 10% urea in 9% NaCl solution, (4) 5% ethanol in 9% NaCl solution, (5) 5% ammonium sulfate ((NH₄)₂SO₄) in 9% NaCl solution, (6) 10% sodium carbonate (NaCO₃) in 9% NaCl solution, (7) 10% magnesium sulfate (MgSO₄) in 9% NaCl solution, (8) 20% glucose in 9% NaCl solution, or (9) 5% PEG (Average MW 20,000) in 9% NaCl solution. Each poultry rinsate sample obtained from the nine wash mediums was passed through microfilters in 10 minutes. In this example, the rinsates were not incubated for enrichment of pathogens and/or microbes from food samples. The poultry rinsate protocol in this example requires no incubation time. The wash media containing a kosmotropic was added to the food sample (e.g., poultry), and the food sample was vigorously rinsed, and the rinsates were applied to filtration membranes for passing through.

300 ml of each sample was passed through the membrane filter, followed by measuring pass-through volume. Table 2 represents data from experiments that were performed. All the experiments were conducted as single-day comparisons to reduce any sample variability throughout time.

TABLE 2
Average percentage of pass-through volume of 300 mL
poultry rinsate passed through filters in 10 min.

| | | % of total | |
|---|---|---|---|
| | | Pass-through | |
| | | volume | |
| | Wash Media | (mL passed | Standard |
| Experiment | (Solution) | through) | Deviation |
| #1 | Distilled water | 92.60% | 4.13% |
| | | (278.92 out | (12.4 out |
| | | of 300 ml) | of 300 ml) |
| #2 | 9% NaCl | 4.30% | 0% |
| | in Distilled | (12.9 out | (0 out |
| | water | of 300 ml) | of 300 ml) |
| #3 | 10% Urea; | 19.70% | 0.27% |
| | 9% NaCl | (59.15 out | (0.8 out |
| | In Distilled | of 300 ml) | of 300 ml) |
| | water | | |
| #4 | 5% Ethanol; | 18.10% | 0.33% |
| | 9% NaCl | (54.4 out | (1 out |
| | in Distilled | of 300 ml) | of 300 ml) |
| | water | | |
| #5 | 5% ammonium | 28.80% | 3.5% |
| | sulfate; | (86.4 out | (10.5 out |
| | 9% NaCl | of 300 ml) | of 300 ml) |
| | in distilled | | |
| | water | | |
| #6 | 5% sodium | 6.76% | 0.27% |
| | carbonate; | (20.3 out | (0.8 out |
| | 9% NaCl | of 300 ml) | of 300 ml) |
| | in distilled | | |
| | water | | |
| #7 | 5% Magnesium | 9.98% | 1.23% |
| | sulfate; | (29.95 out | (3.7 out |
| | 9% NaCl | of 300 ml) | of 300 ml) |
| | in distilled | | |
| | water | | |
| #8 | 20% glucose; | 26.60% | 3.50% |
| | 9% NaCl | (79.75 out | (28.5 out |
| | in distilled | of 300 ml) | of 300 ml) |
| | water | | |
| #9 | 5% PEG MW | 53.40% | 3.57% |
| | 20,000; | (160.05 out | (10.7 out |
| | 9% NaCl | of 300 ml) | of 300 ml) |
| | in distilled | | |
| | water | | |

Experiment 1 demonstrates that the pass-through volume percentage of the positive control (distilled water) is 92.6% and Experiment 2 demonstrates that the pass-through volume percentage of the negative control (9% sodium chloride solution) is 4.3%. In evaluating the impact of additives on salt-buffered mediums, Experiments 3-9 were conducted. Experiments 3 and 4 show that the addition of chaotropic agents (urea and ethanol) improves pass-through volume percentages of salt-buffered mediums to 19.7% and 18.1%, respectively. Experiments 5 through 7 show that the addition of ionic kosmotropic agents (ammonium sulfate, sodium carbonate, and magnesium sulfate) improve pass-through volume percentages of salt-buffered mediums to 28.8%, 6.76%, and 9.98%, respectively. Lastly, Experiments 8 and 9 demonstrate that the addition of non-ionic kosmotropic agents (glucose and PEG 20,000) improve pass-through volume percentages of salt-buffered mediums to 26.6% and 53.4%, respectively.

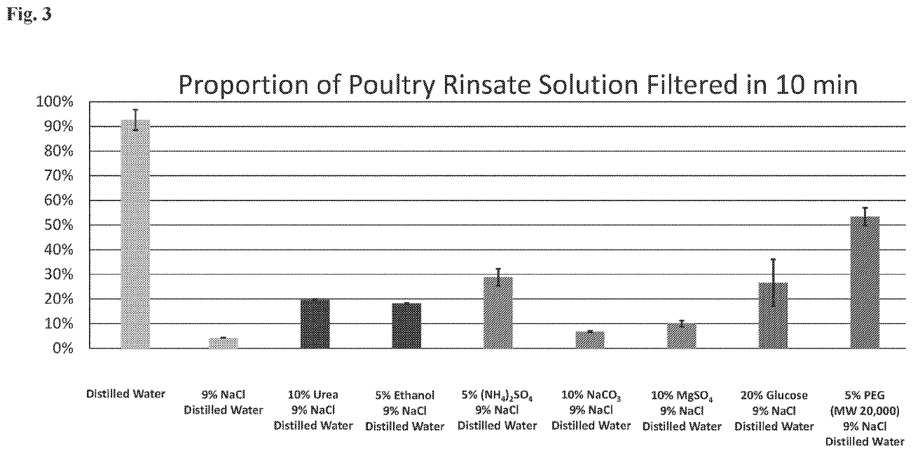

Table 2, as visualized in FIG. 3, presents data on the impact of PEG in improving pass-through volume percentages in poultry rinsates relative with distilled water, chaotropes, ionic kosmotropes, and glucose. The data in Table 2 indicate that 5% PEG MW 20,000 added to the wash media significantly improves the filtration at least 10 times in comparison to the wash media without PEG (9% NaCl in dH₂O) as well as at least 2-8 times better filtration than the wash media (9% NaCl in dH₂O) supplemented with chaotropes, ionic kosmotropes, and/or glucose.

The foregoing description, for purposes of explanation, used specific nomenclature to provide a thorough understanding of the disclosure. However, it will be apparent to one skilled in the art that specific details are not required in order to practice the disclosure. Thus, the foregoing descriptions of specific embodiments of the disclosure are presented for purposes of illustration and description. They are not intended to be exhaustive or to limit the disclosure to the precise forms disclosed; obviously, many modifications and variations are possible in view of the above teachings. The embodiments were chosen and described in order to explain the principles of the disclosure and its practical applications, they thereby enable others skilled in the art to utilize the disclosure and various embodiments with various modifications as are suited to the particular use contemplated.

### Numbered Embodiments of the Disclosure

Notwithstanding the appended claims, the disclosure sets forth the following numbered embodiments:

1. A method of reducing or preventing membrane fouling in a filtration system, the method comprising the steps of:
a) introducing a growth medium or a buffer to a food or beverage to prepare a fluid sample; and
b) treating the fluid sample with a kosmotropic agent;
wherein the fluid sample treated with the kosmotropic agent reduces or prevents the membrane fouling, thereby increasing a volume of the fluid sample that passes through a membrane in the filtration system at least 1.5 times more than the fluid sample not treated with the kosmotropic agent.

2. The method of embodiment 1, wherein the membrane fouling is caused by at least one foulant in the food or beverage.

3. The method of embodiment 2, wherein the at least one foulant comprises a protein.

4. The method of embodiment 3, wherein the protein is an animal protein or a meat protein.

5. The method of embodiment 1, wherein the food or beverage comprises a leaf vegetable, chicken, beef, pork, cheese, dairy, spices, fruit, or combination thereof.

6. The method of embodiment 1, further comprising incubating the fluid sample for growth and proliferation of microorganisms or pathogens to detectable levels.

7. The method of embodiment 6, wherein the kosmotropic agent does not interfere with the growth and proliferation of microorganisms or pathogens.

8. The method of embodiment 1, wherein treating the fluid samples comprises providing the kosmotropic agent to the fluid sample in an amount effective to reduce the membrane fouling.

9. The method of any one of embodiments 1-8, wherein about 1% to about 20% of the fluid sample comprises the kosmotropic agent.

10. The method of any one of embodiments 1-9, wherein about 1.5% to about 15% of the fluid sample comprises the kosmotropic agent.

11. The method of any one of embodiments 1-10, wherein about 2% to about 10% of the fluid sample comprises the kosmotropic agent.

12. The method of any one of embodiments 1-11, wherein the kosmotropic agent is polyethylene glycol (PEG), monosaccharide, disaccharide, polysaccharides, proline, betaine, trehalose, or combination thereof.

13. The method of any one of embodiments 1-12, wherein the kosmotropic agent is polyethylene glycol (PEG) with an average molecular weight of about 2,000 g/mol to about 25,000 g/mol.

14. The method of any one of embodiments 1-13, wherein the kosmotropic agent is polyethylene glycol (PEG) with an average molecular weight of about 3,000 g/mol to about 20,000 g/mol.

15. The method of embodiment 1, wherein the membrane is a microfiltration membrane or an ultrafiltration membrane.

16. The method of embodiment 15, wherein the microfiltration membrane has a pore size within the range of about 0.1 μm to about 10 μm pore size.

17. The method of embodiment 15, wherein the ultrafiltration membrane has a pore size within the range of about 0.01 μm to about 0.1 μm pore size.

18. The method of embodiment 2 or 3, wherein the treating of the kosmotropic agent causes aggregation of the at least one foulant.

19. The method of embodiment 1, wherein the fluid sample treated with the kosmotropic agent passes through the membrane in the filtration system up to 10 times in volume more than the fluid sample not treated with the kosmotropic agent.

20. The method of embodiment 19, wherein the fluid sample treated with the kosmotropic agent passes through the membrane in the filtration system at least 1.5 to 7 times in volume more than the fluid sample not treated with the kosmotropic agent.

21. A method of improving a food safety test process for pathogen detection, the method comprising the steps of:
a) introducing a growth medium or a buffer to a food or beverage to prepare a fluid sample;
b) treating the fluid sample with a kosmotropic agent;
c) processing the fluid sample in a filtration system by passing the fluid sample through a membrane;
d) extracting a retentate of the fluid sample from the filtration system; and
e) detecting presence of pathogen from the extracted retentate;
wherein the fluid sample treated with the kosmotropic agent reduces or prevents membrane fouling, thereby increasing a volume of the fluid sample that passes through a membrane in the filtration system at least 1.5 times more than the fluid sample not treated with the kosmotropic agent.

22. The method of embodiment 21, wherein the membrane fouling is caused by at least one foulant in the food or beverage.

23. The method of embodiment 22, wherein the at least one foulant comprises a protein.

24. The method of embodiment 23, wherein the protein is an animal protein or a meat protein.

25. The method of embodiment 21, wherein the food or beverage comprises a leaf vegetable, chicken, beef, pork, cheese, dairy, spices, fruit, or combination thereof.

26. The method of embodiment 21, further comprising incubating the fluid sample for growth and proliferation of microorganisms or pathogens to detectable levels.

27. The method of embodiment 26, wherein the kosmotropic agent does not interfere with the growth and proliferation of microorganisms or pathogens.

28. The method of embodiment 21, wherein treating the fluid sample comprises providing the kosmotropic agent to the fluid sample in an amount effective to reduce the membrane fouling.

29. The method of any one of embodiments 21-28, wherein about 1% to about 20% of the fluid sample comprises the kosmotropic agent.

30. The method of any one of embodiments 21-29, wherein about 1.5% to about 15% of the fluid sample comprises the kosmotropic agent.

31. The method of any one of embodiments 21-30, wherein about 2% to about 10% of the fluid sample comprises the kosmotropic agent.

32. The method of any one of embodiments 21-31, wherein the kosmotropic agent is polyethylene glycol (PEG), monosaccharide, disaccharide, polysaccharides, proline, betaine, trehalose, or combination thereof.

33. The method of any one of embodiments 21-32, wherein the kosmotropic agent is polyethylene glycol (PEG) with an average molecular weight of about 2,000 g/mol to about 25,000 g/mol.

34. The method of any one of embodiments 21-33, wherein the kosmotropic agent is polyethylene glycol (PEG) with an average molecular weight of about 3,000 g/mol to about 20,000 g/mol.

35. The method of embodiment 21, wherein the membrane is a microfiltration membrane or an ultrafiltration membrane.

36. The method of embodiment 35, wherein the microfiltration membrane has a pore size within the range of about 0.1 μm to about 10 μm pore size.

37. The method of embodiment 35, wherein the ultrafiltration membrane has a pore size within the range of about 0.01 μm to about 0.1 μm pore size.

38. The method of embodiment 22 or 23, wherein the treating of the kosmotropic agent causes aggregation of the at least one foulant.

39. The method of embodiment 21, wherein the fluid sample treated with the kosmotropic agent passes through the membrane in the filtration system up to 10 times in volume more than the fluid sample not treated with the kosmotropic agent.

40. The method of embodiment 39, wherein the fluid sample treated with the kosmotropic agent passes through the membrane in the filtration system at least 1.5 to 7 times in volume more than the fluid sample not treated with the kosmotropic agent.

41. The method of embodiment 21, wherein the detecting of the presence of the pathogen comprises performing one or more of immunoassay, loop-mediated isothermal amplification (LAMP), whole-genome sequencing, polymerase chain reaction (PCR), real-time PCR, and quantitative real-time PCR.

42. A food safety test kit for pathogen detection, comprising:
a) a membrane;
b) a growth medium or a buffer; and
c) a kosmotropic agent that is polyethylene glycol (PEG), monosaccharide, disaccharide, polysaccharides, proline, betaine, trehalose, or combination thereof.

43. The food safety test kit of embodiment 42, wherein the kosmotropic agent is polyethylene glycol (PEG) with an average molecular weight of about 2,000 g/mol to about 25,000 g/mol.

44. The food safety test kit of embodiment 42, wherein the kosmotropic agent is polyethylene glycol (PEG) with an average molecular weight of about 3,000 g/mol to about 20,000 g/mol.

45. The food safety test kit of embodiment 42, wherein the membrane is a microfiltration membrane or an ultrafiltration membrane.

46. The food safety test kit of embodiment 45, wherein the microfiltration membrane has a pore size within the range of about 0.1 μm to about 10 μm pore size.

47. The food safety test kit of embodiment 45, wherein the ultrafiltration membrane has a pore size within the range of about 0.01 μm to about 0.1 μm pore size.

48. A method of reducing or preventing membrane fouling in a filtration system, the method comprising the steps of:
a) treating a food sample with a wash medium comprising a kosmotropic agent to prepare a rinsate; and
b) passing the rinsate through a membrane in a filtration system;
wherein the rinsate comprising the kosmotropic agent reduces or prevents the membrane fouling, thereby increasing a volume of the rinsate that passes through the membrane at least 1.5 times more than the food sample treated with a wash medium not comprising the kosmotropic agent.

49. The method of embodiment 48, wherein the membrane fouling is caused by at least one foulant in the food sample.

50. The method of embodiment 49, wherein the at least one foulant comprises a protein.

51. The method of embodiment 50, wherein the protein is an animal protein or a meat protein.

52. The method of embodiment 48, wherein the food comprises a leaf vegetable, chicken, beef, pork, cheese, dairy, spices, fruit, or combination thereof.

53. The method of embodiment 48, wherein the kosmotropic agent in the wash medium is present in an amount effective to reduce the membrane fouling.

54. The method of any one of embodiments 48-53, wherein about 1% to about 20% of the wash medium comprises the kosmotropic agent.

55. The method of any one of embodiments 48-54, wherein about 1.5% to about 15% of the wash medium comprises the kosmotropic agent.

56. The method of any one of embodiments 48-55, wherein about 2% to about 10% of the wash medium comprises the kosmotropic agent.

57. The method of any one of embodiments 48-56, wherein the kosmotropic agent is polyethylene glycol (PEG), monosaccharide, disaccharide, polysaccharides, proline, betaine, trehalose, or combination thereof.

58. The method of any one of embodiments 48-57, wherein the kosmotropic agent is polyethylene glycol (PEG) with an average molecular weight of about 2,000 g/mol to about 25,000 g/mol.

59. The method of any one of embodiments 48-58, wherein the kosmotropic agent is polyethylene glycol (PEG) with an average molecular weight of about 3,000 g/mol to about 20,000 g/mol.

60. The method of embodiment 48, wherein the membrane is a microfiltration membrane or an ultrafiltration membrane.

61. The method of embodiment 60, wherein the microfiltration membrane has a pore size within the range of about 0.1 μm to about 10 μm pore size.

62. The method of embodiment 60, wherein the ultrafiltration membrane has a pore size within the range of about 0.01 μm to about 0.1 μm pore size.

63. The method of embodiment 49 or 50, wherein the kosmotropic agent causes aggregation of the at least one foulant.

64. The method of embodiment 48, wherein the rinsate comprising the kosmotropic agent passes through the membrane in the filtration system up to 10 times in volume more than the food sample treated with the wash medium not comprising the kosmotropic agent.

65. The method of embodiment 48, wherein the rinsate comprising the kosmotropic agent passes through the membrane in the filtration system at least 1.5 to 8 times in volume more than the food sample treated with the wash medium not comprising the kosmotropic agent.

66. A method of improving a food safety test process for pathogen detection, the method comprising the steps of.
a) treating a food sample with a wash medium comprising a kosmotropic agent to prepare a rinsate;
b) passing the rinsate through a membrane in a filtration system;
c) extracting a retentate of the rinsate from the filtration system; and
d) detecting presence of pathogen from the extracted retentate;
wherein the rinsate comprising the kosmotropic agent reduces or prevents the membrane fouling, thereby increasing a volume of the rinsate that passes through the membrane at least 1.5 times more than the food sample treated with a wash medium not comprising the kosmotropic agent.

67. The method of embodiment 66, wherein the membrane fouling is caused by at least one foulant in the food sample.

68. The method of embodiment 67, wherein the at least one foulant comprises a protein.

69. The method of embodiment 68, wherein the protein is an animal protein or a meat protein.

70. The method of embodiment 66, wherein the food comprises a leaf vegetable, chicken, beef, pork, cheese, dairy, spices, fruit, or combination thereof.

71. The method of embodiment 66, wherein the kosmotropic agent in the wash medium is present in an amount effective to reduce the membrane fouling.

72. The method of any one of embodiments 66-71, wherein about 1% to about 20% of the wash medium comprises the kosmotropic agent.

73. The method of any one of embodiments 66-72, wherein about 1.5% to about 15% of the wash medium comprises the kosmotropic agent.

74. The method of any one of embodiments 66-73, wherein about 2% to about 10% of the wash medium comprises the kosmotropic agent.

75. The method of any one of embodiments 66-74, wherein the kosmotropic agent is polyethylene glycol (PEG), monosaccharide, disaccharide, polysaccharides, proline, betaine, trehalose, or combination thereof.

76. The method of any one of embodiments 66-75, wherein the kosmotropic agent is polyethylene glycol (PEG) with an average molecular weight of about 2,000 g/mol to about 25,000 g/mol.

77. The method of any one of embodiments 66-76, wherein the kosmotropic agent is polyethylene glycol (PEG) with an average molecular weight of about 3,000 g/mol to about 20,000 g/mol.

78. The method of embodiment 66, wherein the membrane is a microfiltration membrane or an ultrafiltration membrane.

79. The method of embodiment 78, wherein the microfiltration membrane has a pore size within the range of about 0.1 μm to about 10 μm pore size.

80. The method of embodiment 78, wherein the ultrafiltration membrane has a pore size within the range of about 0.01 μm to about 0.1 μm pore size.

81. The method of embodiment 67 or 68, wherein the kosmotropic agent causes aggregation of the at least one foulant.

82. The method of embodiment 66, wherein the rinsate comprising the kosmotropic agent passes through the membrane in the filtration system up to 10 times in volume more than the food sample treated with the wash medium not comprising the kosmotropic agent.

83. The method of embodiment 66, wherein the rinsate comprising the kosmotropic agent passes through the membrane in the filtration system at least 1.5 to 8 times in volume more than the food sample treated with the wash medium not comprising the kosmotropic agent.

84. The method of embodiment 66, wherein the detecting of the presence of the pathogen comprises performing one or more of immunoassay, loop-mediated isothermal amplification (LAMP), whole-genome sequencing, polymerase chain reaction (PCR), real-time PCR, and quantitative real-time PCR.

85. The method of embodiment 48 or 66, wherein the preparing of the rinsate is the rinsing of the food sample with the wash medium comprising the kosmotropic agent.

86. A food safety test kit for pathogen detection, comprising:
a) a membrane;
b) a wash medium; and
c) a kosmotropic agent that is polyethylene glycol (PEG), monosaccharide, disaccharide, polysaccharides, proline, betaine, trehalose, or combination thereof.

87. The food safety test kit of embodiment 86, wherein the kosmotropic agent is polyethylene glycol (PEG) with an average molecular weight of about 2,000 g/mol to about 25,000 g/mol.

88. The food safety test kit of embodiment 86, wherein the kosmotropic agent is polyethylene glycol (PEG) with an average molecular weight of about 3,000 g/mol to about 20,000 g/mol.

89. The food safety test kit of embodiment 86, wherein the membrane is a microfiltration membrane or an ultrafiltration membrane.

90. The food safety test kit of embodiment 89, wherein the microfiltration membrane has a pore size within the range of about 0.1 μm to about 10 μm pore size.

91. The food safety test kit of embodiment 89, wherein the ultrafiltration membrane has a pore size within the range of about 0.01 μm to about 0.1 μm pore size.

1. A method of reducing or preventing membrane fouling in a filtration system, the method comprising the steps of:
a) introducing a growth medium or a buffer to a food or beverage to prepare a fluid sample; and
b) treating the fluid sample with a kosmotropic agent;
wherein the fluid sample treated with the kosmotropic agent reduces or prevents the membrane fouling, thereby increasing a volume of the fluid sample that passes through a membrane in the filtration system at least 1.5 times more than the fluid sample not treated with the kosmotropic agent.

2. The method of claim 1, wherein the membrane fouling is caused by at least one foulant in the food or beverage.

3. The method of claim 2, wherein the at least one foulant comprises a protein.

4. The method of claim 3, wherein the protein is an animal protein or a meat protein.

5. The method of claim 1, wherein the food or beverage comprises a leaf vegetable, chicken, beef, pork, cheese, dairy, spices, fruit, or combination thereof.

6. The method of claim 1, further comprising incubating the fluid sample for growth and proliferation of microorganisms or pathogens to detectable levels.

7. The method of claim 6, wherein the kosmotropic agent does not interfere with the growth and proliferation of microorganisms or pathogens.

8. The method of claim 1, wherein treating the fluid samples comprises providing the kosmotropic agent to the fluid sample in an amount effective to reduce the membrane fouling.

9. The method of claim 1, wherein about 1% to about 20% of the fluid sample comprises the kosmotropic agent.

10. The method of claim 1, wherein about 1.5% to about 15% of the fluid sample comprises the kosmotropic agent.

11. The method of claim 1, wherein about 2% to about 10% of the fluid sample comprises the kosmotropic agent.

12. The method of claim 1, wherein the kosmotropic agent is polyethylene glycol (PEG), monosaccharide, disaccharide, polysaccharides, proline, betaine, trehalose, or combination thereof.

13. The method of claim 1, wherein the kosmotropic agent is polyethylene glycol (PEG) with an average molecular weight of about 2,000 g/mol to about 25,000 g/mol.

14. The method of claim 1, wherein the kosmotropic agent is polyethylene glycol (PEG) with an average molecular weight of about 3,000 g/mol to about 20,000 g/mol.

15. The method of claim 1, wherein the membrane is a microfiltration membrane or an ultrafiltration membrane.

16. The method of claim 15, wherein the microfiltration membrane has a pore size within the range of about 0.1 μm to about 10 μm pore size.

17. The method of claim 15, wherein the ultrafiltration membrane has a pore size within the range of about 0.01 μm to about 0.1 μm pore size.

18. The method of claim 2, wherein the treating of the kosmotropic agent causes aggregation of the at least one foulant.

19. The method of claim 1, wherein the fluid sample treated with the kosmotropic agent passes through the membrane in the filtration system up to 10 times in volume more than the fluid sample not treated with the kosmotropic agent.

20. The method of claim 1, wherein the fluid sample treated with the kosmotropic agent passes through the membrane in the filtration system at least 1.5 to 7 times in volume more than the fluid sample not treated with the kosmotropic agent.

21. A method of improving a food safety test process for pathogen detection, the method comprising the steps of:
a) introducing a growth medium or a buffer to a food or beverage to prepare a fluid sample;
b) treating the fluid sample with a kosmotropic agent;
c) processing the fluid sample in a filtration system by passing the fluid sample through a membrane;
d) extracting a retentate of the fluid sample from the filtration system; and
e) detecting presence of pathogen from the extracted retentate;
wherein the fluid sample treated with the kosmotropic agent reduces or prevents membrane fouling, thereby increasing a volume of the fluid sample that passes through a membrane in the filtration system at least 1.5 times more than the fluid sample not treated with the kosmotropic agent.

22. The method of claim 21, wherein the membrane fouling is caused by at least one foulant in the food or beverage.

23. The method of claim 22, wherein the at least one foulant comprises a protein.

24. The method of claim 23, wherein the protein is an animal protein or a meat protein.

25. The method of claim 21, wherein the food or beverage comprises a leaf vegetable, chicken, beef, pork, cheese, dairy, spices, fruit, or combination thereof.

26. The method of claim 21, further comprising incubating the fluid sample for growth and proliferation of microorganisms or pathogens to detectable levels.

27. The method of claim 26, wherein the kosmotropic agent does not interfere with the growth and proliferation of microorganisms or pathogens.

28. The method of claim 21, wherein treating the fluid sample comprises providing the kosmotropic agent to the fluid sample in an amount effective to reduce the membrane fouling.

29. The method of claim 21, wherein about 1% to about 20% of the fluid sample comprises the kosmotropic agent.

30. The method of claim 21, wherein about 1.5% to about 15% of the fluid sample comprises the kosmotropic agent.

31. The method of claim 21, wherein about 2% to about 10% of the fluid sample comprises the kosmotropic agent.

32. The method of claim 21, wherein the kosmotropic agent is polyethylene glycol (PEG), monosaccharide, disaccharide, polysaccharides, proline, betaine, trehalose, or combination thereof.

33. The method of claim 21, wherein the kosmotropic agent is polyethylene glycol (PEG) with an average molecular weight of about 2,000 g/mol to about 25,000 g/mol.

34. The method of claim 21, wherein the kosmotropic agent is polyethylene glycol (PEG) with an average molecular weight of about 3,000 g/mol to about 20,000 g/mol.

35. The method of claim 21, wherein the membrane is a microfiltration membrane or an ultrafiltration membrane.

36. The method of claim 35, wherein the microfiltration membrane has a pore size within the range of about 0.1 μm to about 10 μm pore size.

37. The method of claim 35, wherein the ultrafiltration membrane has a pore size within the range of about 0.01 μm to about 0.1 μm pore size.

38. The method of claim 22, wherein the treating of the kosmotropic agent causes aggregation of the at least one foulant.

39. The method of claim 21, wherein the fluid sample treated with the kosmotropic agent passes through the membrane in the filtration system up to 10 times in volume more than the fluid sample not treated with the kosmotropic agent.

40. The method of claim 21, wherein the fluid sample treated with the kosmotropic agent passes through the membrane in the filtration system at least 1.5 to 7 times in volume more than the fluid sample not treated with the kosmotropic agent.

41. The method of claim 21, wherein the detecting of the presence of the pathogen comprises performing one or more of immunoassay, loop-mediated isothermal amplification (LAMP), whole-genome sequencing, polymerase chain reaction (PCR), real-time PCR, and quantitative real-time PCR.

42. A food safety test kit for pathogen detection, comprising:
a) a membrane;
b) a growth medium or a buffer; and
c) a kosmotropic agent that is polyethylene glycol (PEG), monosaccharide, disaccharide, polysaccharides, proline, betaine, trehalose, or combination thereof.

43. The food safety test kit of claim 42, wherein the kosmotropic agent is polyethylene glycol (PEG) with an average molecular weight of about 2,000 g/mol to about 25,000 g/mol.

44. The food safety test kit of claim 42, wherein the kosmotropic agent is polyethylene glycol (PEG) with an average molecular weight of about 3,000 g/mol to about 20,000 g/mol.

45. The food safety test kit of claim 42, wherein the membrane is a microfiltration membrane or an ultrafiltration membrane.

46. The food safety test kit of claim 45, wherein the microfiltration membrane has a pore size within the range of about 0.1 μm to about 10 μm pore size.

47. The food safety test kit of claim 45, wherein the ultrafiltration membrane has a pore size within the range of about 0.01 μm to about 0.1 μm pore size.

48. A method of reducing or preventing membrane fouling in a filtration system, the method comprising the steps of:
a) treating a food sample with a wash medium comprising a kosmotropic agent to prepare a rinsate; and
b) passing the rinsate through a membrane in a filtration system;
wherein the rinsate comprising the kosmotropic agent reduces or prevents the membrane fouling, thereby increasing a volume of the rinsate that passes through the membrane at least 1.5 times more than the food sample treated with a wash medium not comprising the kosmotropic agent.

49. The method of claim 48, wherein the membrane fouling is caused by at least one foulant in the food sample.

50. The method of claim 49, wherein the at least one foulant comprises a protein.

51. The method of claim 50, wherein the protein is an animal protein or a meat protein.

52. The method of claim 48, wherein the food comprises a leaf vegetable, chicken, beef, pork, cheese, dairy, spices, fruit, or combination thereof.

53. The method of claim 48, wherein the kosmotropic agent in the wash medium is present in an amount effective to reduce the membrane fouling.

54. The method of claim 48, wherein about 1% to about 20% of the wash medium comprises the kosmotropic agent.

55. The method of claim 48, wherein about 1.5% to about 15% of the wash medium comprises the kosmotropic agent.

56. The method of claim 48, wherein about 2% to about 10% of the wash medium comprises the kosmotropic agent.

57. The method of claim 48, wherein the kosmotropic agent is polyethylene glycol (PEG), monosaccharide, disaccharide, polysaccharides, proline, betaine, trehalose, or combination thereof.

58. The method of claim 48, wherein the kosmotropic agent is polyethylene glycol (PEG) with an average molecular weight of about 2,000 g/mol to about 25,000 g/mol.

59. The method of claim 48, wherein the kosmotropic agent is polyethylene glycol (PEG) with an average molecular weight of about 3,000 g/mol to about 20,000 g/mol.

60. The method of claim 48, wherein the membrane is a microfiltration membrane or an ultrafiltration membrane.

61. The method of claim 60, wherein the microfiltration membrane has a pore size within the range of about 0.1 μm to about 10 μm pore size.

62. The method of claim 60, wherein the ultrafiltration membrane has a pore size within the range of about 0.01 μm to about 0.1 μm pore size.

63. The method of claim 49, wherein the kosmotropic agent causes aggregation of the at least one foulant.

64. The method of claim 48, wherein the rinsate comprising the kosmotropic agent passes through the membrane in the filtration system up to 10 times in volume more than the food sample treated with the wash medium not comprising the kosmotropic agent.

65. The method of claim 48, wherein the rinsate comprising the kosmotropic agent passes through the membrane in the filtration system at least 1.5 to 8 times in volume more than the food sample treated with the wash medium not comprising the kosmotropic agent.

66. A method of improving a food safety test process for pathogen detection, the method comprising the steps of:
a) treating a food sample with a wash medium comprising a kosmotropic agent to prepare a rinsate;
b) passing the rinsate through a membrane in a filtration system;
c) extracting a retentate of the rinsate from the filtration system; and
d) detecting presence of pathogen from the extracted retentate;
wherein the rinsate comprising the kosmotropic agent reduces or prevents the membrane fouling, thereby increasing a volume of the rinsate that passes through the membrane at least 1.5 times more than the food sample treated with a wash medium not comprising the kosmotropic agent.

67. The method of claim 66, wherein the membrane fouling is caused by at least one foulant in the food sample.

68. The method of claim 67, wherein the at least one foulant comprises a protein.

69. The method of claim 68, wherein the protein is an animal protein or a meat protein.

70. The method of claim 66, wherein the food comprises a leaf vegetable, chicken, beef, pork, cheese, dairy, spices, fruit, or combination thereof.

71. The method of claim 66, wherein the kosmotropic agent in the wash medium is present in an amount effective to reduce the membrane fouling.

72. The method of claim 66, wherein about 1% to about 20% of the wash medium comprises the kosmotropic agent.

73. The method of claim 66, wherein about 1.5% to about 15% of the wash medium comprises the kosmotropic agent.

74. The method of claim 66, wherein about 2% to about 10% of the wash medium comprises the kosmotropic agent.

75. The method of claim 66, wherein the kosmotropic agent is polyethylene glycol (PEG), monosaccharide, disaccharide, polysaccharides, proline, betaine, trehalose, or combination thereof.

76. The method of claim 66, wherein the kosmotropic agent is polyethylene glycol (PEG) with an average molecular weight of about 2,000 g/mol to about 25,000 g/mol.

77. The method of claim 66, wherein the kosmotropic agent is polyethylene glycol (PEG) with an average molecular weight of about 3,000 g/mol to about 20,000 g/mol.

78. The method of claim 66, wherein the membrane is a microfiltration membrane or an ultrafiltration membrane.

79. The method of claim 78, wherein the microfiltration membrane has a pore size within the range of about 0.1 μm to about 10 μm pore size.

80. The method of claim 78, wherein the ultrafiltration membrane has a pore size within the range of about 0.01 μm to about 0.1 μm pore size.

81. The method of claim 67, wherein the kosmotropic agent causes aggregation of the at least one foulant.

82. The method of claim 66, wherein the rinsate comprising the kosmotropic agent passes through the membrane in the filtration system up to 10 times in volume more than the food sample treated with the wash medium not comprising the kosmotropic agent.

83. The method of claim 66, wherein the rinsate comprising the kosmotropic agent passes through the membrane in the filtration system at least 1.5 to 8 times in volume more than the food sample treated with the wash medium not comprising the kosmotropic agent.

84. The method of claim 66, wherein the detecting of the presence of the pathogen comprises performing one or more of immunoassay, loop-mediated isothermal amplification (LAMP), whole-genome sequencing, polymerase chain reaction (PCR), real-time PCR, and quantitative real-time PCR.

85. The method of claim 48, wherein the preparing of the rinsate is the rinsing of the food sample with the wash medium comprising the kosmotropic agent.

86. A food safety test kit for pathogen detection, comprising:
a) a membrane;
b) a wash medium; and
c) a kosmotropic agent that is polyethylene glycol (PEG), monosaccharide, disaccharide, polysaccharides, proline, betaine, trehalose, or combination thereof.

87. The food safety test kit of claim 86, wherein the kosmotropic agent is polyethylene glycol (PEG) with an average molecular weight of about 2,000 g/mol to about 25,000 g/mol.

88. The food safety test kit of claim 86, wherein the kosmotropic agent is polyethylene glycol (PEG) with an average molecular weight of about 3,000 g/mol to about 20,000 g/mol.

89. The food safety test kit of claim 86, wherein the membrane is a microfiltration membrane or an ultrafiltration membrane.

90. The food safety test kit of claim 89, wherein the microfiltration membrane has a pore size within the range of about 0.1 μm to about 10 μm pore size.

91. The food safety test kit of claim 89, wherein the ultrafiltration membrane has a pore size within the range of about 0.01 μm to about 0.1 μm pore size.

92. The method of claim 66, wherein the preparing of the rinsate is the rinsing of the food sample with the wash medium comprising the kosmotropic agent.
